(19) United States
(12) Patent Application Publication
(10) Pub. No.: US 2018/0173886 A1
(43) Pub. Date: Jun. 21, 2018

(54) Collaborative Database to Promote Data Sharing, Synchronization, and Access Control

(71) Applicants: Joseph E Dryer, Houston, TX (US); Robert Raschilla, Houston, TX (US); Juan Diego Gimenez, Mexico City (MX); Mayia Petrissans, Paris (FR); Jinhan Zhong, Calgary (CA); Ian Lambert, Houston, TX (US)

(72) Inventors: Joseph E Dryer, Houston, TX (US); Robert Raschilla, Houston, TX (US); Juan Diego Gimenez, Mexico City (MX); Mayia Petrissans, Paris (FR); Jinhan Zhong, Calgary (CA); Ian Lambert, Houston, TX (US)

(21) Appl. No.: 15/842,879

(22) Filed: Dec. 15, 2017

Related U.S. Application Data
(60) Provisional application No. 62/434,764, filed on Dec. 15, 2016.

(51) Int. Cl. G06F 21/62; G06F 21/30; H04L 29/06

(52) U.S. Cl. CPC G06F 21/6218; H04L 67/141; H04L 63/0428; G06F 21/30

(57) ABSTRACT

An organization of database functionality provides for at least three types of databases or database logical partitions: a master database with controlled object insertion for reference and critical data entries to which others have read-only access; a number of team databases which function as “sandboxes” with maximum flexibility within a team without affecting or being affected by other teams; and a number of customer databases to securely facilitate the communication from the other types to third parties outside the company. This structure promotes collaboration and protects critical database objects from corruption by employees while allowing additional flexibility within a team and in communication with third parties. Associated devices and methods are disclosed as well.

### CROSS-REFERENCE TO RELATED APPLICATIONS

The present application claims priority to U.S. Provisional Application No. 62/434,764, filed Dec. 15, 2016, entitled, “METHOD FOR DATABASE STRUCTURE TO PROMOTE INTRA-COMPANY AND INTER-COMPANY COLLABORATION,” by the same inventors, which is incorporated by reference herein, in its entirety.

### TECHNICAL FIELD

This disclosure is directed toward an organization of a collaborative database to encourage collaboration while working with data in the database and in contacts to third party collaborators. The organization discussed addresses problems encountered in the disruption of database entries when there may be frequent user modifications and variations of database objects.

### BACKGROUND

In the past fifty years oilfield data management has gone from being a paper-based data medium to today's “digital oilfield.” In response to the increasing data flow in a digital format, companies first went to data analysis at workstations, perhaps with centralized server databases. The control of the data in such a system suffered from a failure to adequately address the fundamental requirements: data must be accessible and cataloged; data is valuable and must be protected from intrusion and storage failure; data must be manipulated and improved; data must be shared both within a company but also securely shared with designated third parties.

The incorporation of relational database management systems has solved the access to cataloged issue, provided the schema contains the appropriate keys. Commercial databases can also be easily backed up and protected, satisfying protection from intrusion and failure. The operation on centrally-stored data by copies of local workstations or PCs raises the question of multiple backups (central and local) and the fragmentation of data entries complicates the accessing and cataloging of all copies of data.

In oil and gas exploration the information on wells is an example where data is often modified. It is typical that drilling logs are edited to match other logs and are used in calculations in an attempt to better understand the well environment. An additional complication is that specialists, such as petrophysicists and geologists, may have different interpretations and different models of a well. This may lead to multiple valid edits of the same well data. If these logs are accumulated in a flat file system, it becomes a very time-consuming and error-prone process to keep track of the file versions caused by these conflicting edits. In particular, edits may overwrite the original data entries which may have been previously used in calculations, thus making those calculations irreproducible. There is also a problem with distinguishing across data entry versions making it difficult to determine which entries represent the authoritative entries. It is difficult to track what changes were made to modified entries, and which versions were previously used. A major problem in versioning of this changing data, sometimes referred to as “transient” data is that different disciplines may be trading edited curves back and forth with each discipline making what is valid changes according to their discipline's interpretation of what the data represents.

One touted advantage of the “digital oilfield” was the ability to share data between players in the oilfield: drilling companies, service companies, oilfield financiers and owners of the oilfield. Each of these players may have a common interest in well information. In oilfield exploration databases the major key is usually a well or wellbore. Standardized formats for data sharing (DLIS, LAS, CSV, etc.) have been developed to facilitate data exchanges. However, these formats may produce very large files. Accordingly, the exchange of data with field units (likely suffering from a limited Ethernet bandwidth) has been inconvenient, in part because data files in standard formats may be many megabytes in size. This situation may be complicated when a view of the data is hidden within the exchanged data. The exchanged data often includes a well logging run including the outputs of many logging tools in which there may be no immediate interest.

To alleviate this organizational problem many systems (e.g., Geolog, Petrel Decision, Interactive Petrophysics) organize the well information into databases. Without additional organization, such databases still reference a confusing mixture of variations of the same log entries. Thus, even with a relational database, there is a time-consuming, error-prone search for authoritative entries and authoritative entries can be overwritten. Collaboration between users is inhibited when there is a fear that a user can modify and overwrite documents. Users who need to actively experiment with different interpretation models are inhibited by the fear that they might interfere with other users. Current systems which attempt to address some of these problems include version control systems such as GIT. A version control system is defined as “a system that records changes to a file or set of files over time so that you can recall specific versions later.” This is useful and advisable but does not eliminate the confusion as to which version is the accepted standard and which version is applicable to varying team groups. For example, different team groups can be investigating different zones within a well and can modify logs within those well zones without regard to the effect of shifting their zone of interest may have on well zones that other team groups are investigating. For each such group, the modification within their zone is a valid modification without regard to the fact that other well zones have been modified. Similarly, access control (as explained by U.S. Pat. No. 8,8875,224 B2 by Grosss et al.) is also useful and advisable but does not address the issue of where modified logs should be saved to preserve authoritative versions and avoid affecting the logs of other users, such as those working in different well zones. To solve these and other problems a collaborative database to promote data sharing, synchronization, and access control is disclosed.

### BRIEF DESCRIPTION OF THE DRAWINGS

For a detailed description of various examples, reference will now be made to the accompanying drawings that are briefly described here.

FIG. 1 illustrates a block diagram of an embodiment of a networked computing infrastructure 100 where embodiments of the present disclosure may operate.

FIG. 2 illustrates a high-level block diagram 200 of a processing device (computing system) that may be used to implement one or more disclosed embodiments.

FIG. 3 illustrates one possible relationship of the databases or databases segments, according to one or more disclosed embodiments.

FIG. 4 illustrates how data entries may be incorporated into the “master” and “team” databases, according to one or more disclosed embodiments.

FIG. 5 illustrates a possible connection between the company database and third parties to whom the company wishes to communicate company database objects, according to one or more disclosed embodiments.

FIG. 6 illustrates one implementation of team user permissions, according to one or more disclosed embodiments.

FIG. 7 illustrates a database implementation based on the permissions in FIG. 6, according to one or more disclosed embodiments.

### DETAILED DESCRIPTION

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form to avoid obscuring the disclosed embodiments. Moreover, the language used in this disclosure has been principally selected for readability and instructional purposes, and may not have been selected to delineate or circumscribe the inventive subject matter, resorting to the claims being necessary to determine such inventive subject matter. Reference in the specification to “one embodiment” or to “an embodiment” means that a particular feature, structure, or characteristic described in connection with the embodiments is included in at least one embodiment.

The term “computing system” is generally taken to refer to at least one electronic computing device that includes, but is not limited to, a single computer, virtual machine, virtual container, host, server, laptop, and/or mobile device or to a plurality of electronic computing devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the terms “application” and “function” refer to one or more computing modules, programs, processes, workloads, threads and/or a set of computing instructions executed by a computing system. Example embodiments of applications and functions include software modules, software objects, software instances and/or other types of executable code. Note, the use of the term “application instance” when used in the context of cloud computing refers to an instance within the cloud infrastructure for executing applications (e.g., for a customer in that customer's isolated instance).

While the examples listed in this disclosure are designed for well logs, it will be apparent to one skilled in the art having benefit of that disclosure that in the general case databases can include records of any type of data (e.g. PDF files, text files, photographs, etc.) and similar concerns to those addressed here exist whenever records are changeable by different interacting groups. Accordingly, it is envisioned that techniques described herein may be applicable to many kinds of data in addition to well logs.

In order to encourage collaboration within an upstream oil and gas company, it may be beneficial to provide a means to easily separate authoritative or reference database objects which should be protected against accidental manipulation by users. At the same time, it may be desirable for users who are actively modifying database objects to investigate possible entity interpretations be free to make changes while not affecting the core data entries or affecting other users actively modifying the same entity in other disciplines. In addition, securely communicating database objects with customers or principals in a form amenable to viewing prior to downloading may be advantageous. This may allow for a common view of the data by all interested parties and avoid downloading of large data objects which may ultimately turn out to be unusable.

According to one embodiment of the present disclosure, a collaborative database management system is provided that includes segmenting the database into at least three types of interrelated databases or database segments. A three-way segmentation embodiment may be used to cooperatively solve the problems of secure basic entries, manipulatable team user entries, and properly viewable customer entries. A typical relational database (or databases) has normal overall security features with usual abilities, such as setting entry user access levels to restrict any data object access to only those users with a sufficient authority clearance level and may be utilized as part of the overall solution in this example embodiment.

The first type of database referenced in this embodiment, referred to (for this example) as the “master” database, includes the entries essential to the enterprise (e.g., oilfield company) which should not be modified by users without review. This master database is typically under control of one or more administrators who have the exclusive ability to add entries to this database and delete entries from this database. All other authorized users have a read-only access to entries in the master database. This means that authorized users can access these basic, or “master”, entries in a read-only manner for use in calculations or displays but cannot save any of their modifications of these entries to the “master” database without permission (and possibly assistance) of the administrator. The database form of the master database as described throughout this disclosure may provide the restricted access means for avoiding unapproved corruption of master objects.

The second type of database referenced in this embodiment, is referred to (for this example) as the one or more “team” databases. Each of the team databases, in this example, includes a “team area” and “team entries”. Each team database has team users or members, who can be granted read, write, edit, insert or delete permissions. A person can be a team member in more than one team database. Data entries created by an authorized user by import, editing an existing data record or by means of calculation from existing data entries are by default placed into whatever “team area” or “team areas” that the user logged into at the start of the session. An authorized user can also import any additional data of any type he finds useful to his team into the team he logged into. Any team entries that should be shared with all other teams can be submitted to the “master” database administrator for inclusion into the master database. The database form of a team database as described throughout this disclosure may provide the authorized access means for allowing authorized access to team members, authorizing read-only access to any master database entries, and capturing of any new or changed database object created by team members.

The third type of database referenced in this embodiment, referred to (for this example) as the “customer database”, includes entries that are intended to be shared with third parties such as a client or principal. The use of the customer database (or customer database segment) is to isolate data as much as possible from other databases and database segments for overall security. In practice, the customer may be provided access to only the entries in this customer database. A preferred method for the customer to access this customer database may be via a secure viewer to the objects in the “customer” database” (e.g., a web browser with restricted access to the database and client JavaScript-type code and authorization). Visualization (e.g. colors, line type, log cross-plots, etc.) may be specified to the viewer utilized by the third party. This viewer could include a means to insert objects specified by the customer back into the customer database and thus provide two-way communication. The use of the assigned viewer may then allow confirmation and monitoring of any third party's access to objects in the customer database. Monitoring and reporting may initiate a customer follow-up if a communication from a customer regarding objects viewed is not timely retrieved. The database form of the customer database as described throughout this disclosure may provide the transferring of database objects means to move database objects from any authorized master or team database and a means for securing transfer of objects in a customer database to authorized third parties.

The organization of the system into three types of interacting databases may be accomplished by providing separate databases with a provision for exchanging objects between the separate databases (as in vertically partitioned databases). Alternatively, the three types of interactive databases may be configured as logical partitions within a single database such that the database types within the single database can be distinguished. In some embodiments, a combination of separate databases and logical partitions may be desirable. In any implementation, the type specification may be used to restrict access, monitor access, and to provide a method to define access controls. For simplicity, this discussion refers to each database type as a database regardless of the specific implementation (e.g., separate database or database logical partition). Whatever method of structure is used to distinguish these three types of database, each type includes the automatic assignment of access depending on the user's type. This may allow the automatic assignment of database permissions in a form easily understood by all interested parties and users.

As briefly mentioned above, the examples of this disclosure are directed to energy applications. However, it should be understood that the need for collaboration is a common objective where teams are interacting with data. Accordingly, the disclosed embodiments and the form of organization proposed may have applications in a wide range of industries for a wide range of data object types. The organization of data objects within a database as explained throughout this disclosure may also be considered as a database partition into specific knowledge nodes.

In short, the presently disclosed embodiments may allow for maintaining a body of database entries that are immune from corruption by casual users (the master database) while concurrently allowing a body of users (members of a team database) free access to modify database entries without concern that this would conflict with the “master” database or any other team. This organization and implementation may promote collaboration by freeing users from concerns of overlapping intracompany conflicts. The ability to share entries with third parties in a secure manner and with a defined view may further promote intercompany collaboration (e.g., across teams and with customers).

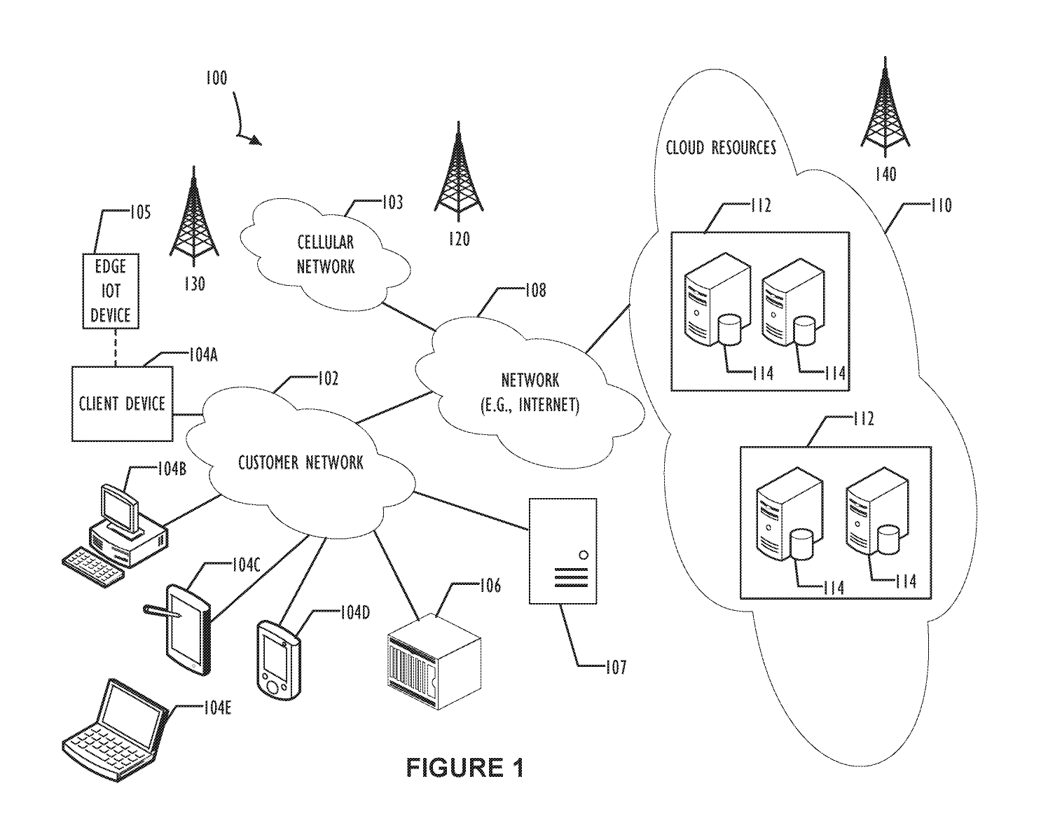

With reference to FIG. 1, an example block diagram illustrates an embodiment of a networked computing infrastructure 100 where embodiments of the present disclosure may operate. Networked computing infrastructure 100 comprises a customer network 102, network 108, and a “backend” cloud or server resources platform/network 110. In one embodiment, the customer network 102 may be a local private network, such as local area network (LAN) that includes a variety of network devices that include, but are not limited to switches, servers, and routers. Each of these networks can contain wired or wireless programmable devices and operate using any number of network protocols (e.g., TCP/IP) and connection technologies (e.g., WiFi® networks, Bluetooth®). Wi-Fi is a registered trademark of the Wi-Fi Alliance. Bluetooth is a registered trademark of Bluetooth Special Interest Group. In another embodiment, customer network 102 represents an enterprise network that could include or be communicatively coupled to one or more local area networks (LANs), virtual networks, data centers, and/or other remote networks (e.g., 108, 112). As shown in FIG. 1, customer network 102 may be connected to one or more client devices 104A-E and allow the client devices to communicate with each other and/or with backend cloud or server resources platform/network 110. Client devices 104A-E may be computing systems such as desktop computer 104B, tablet computer 104C, mobile phone 104D, laptop computer (shown as wireless) 104E, and/or other types of computing systems generically shown as client device 104A. Networked computing infrastructure 100 may also include other types of devices generally referred to as Internet of Things (IoT) (e.g., edge IOT device 105) that may be configured to send and receive information via a network to access cloud computing services or interact with a remote web browser application (e.g., to receive configuration information). FIG. 1 also illustrates that customer network 102 may be connected to a local compute resource 106 that may include a server, access point, router, or other device configured to provide for local computational resources and/or to facilitate communication amongst networks and devices. For example, local compute resource 106 may be one or more physical local hardware devices configured to communicate with wireless network devices and/or facilitate communication of data between customer network 102 and other networks such as network 108 and backend cloud or server resources platform/network 110. Local compute resource 106 may also facilitate communication between other external applications, data sources, and services, and customer network 102. FIG. 1 also illustrates that customer network 102 may be connected to a computer configured to execute a management, instrumentation, and discovery (MID) server 107. For example, MID server 107 may be a Java application that runs as a Windows service or UNIX daemon. MID server 107 may be configured to assist functions such as, but not necessarily limited to, discovery, orchestration, service mapping, service analytics, and event management. MID server 107 may be configured to perform tasks for a cloud-based instance while never initiating communication directly to the cloud-instance by utilizing a work queue architecture. This configuration may assist in addressing security concerns by eliminating that path of direct communication initiation.

Networked computing infrastructure 100 also includes cellular network 103 for use with mobile communication devices. Mobile cellular networks support mobile phones and many other types of mobile devices such as laptops etc. Mobile devices in networked computing infrastructure 100 are illustrated as mobile phone 104D, laptop 104E, and tablet 104C. A mobile device such as mobile phone 104D may interact with one or more mobile provider networks as the mobile device moves, typically interacting with a plurality of mobile network towers 120, 130, and 140 for connecting to the cellular network 103. Although referred to as a cellular network in FIG. 1, a mobile device may interact with towers of more than one provider network, as well as with multiple non-cellular devices, such as wireless access points and routers (e.g., local compute resource 106). In addition, the mobile devices may interact with other mobile devices or with non-mobile devices such as desktop computer 104B and various types of client devices 104A for desired services. Although not specifically illustrated in FIG. 1, customer network 102 may also include a dedicated network device (e.g., gateway or router) or a combination of network devices that implement a customer firewall or intrusion protection system.

FIG. 1 illustrates that customer network 102 is coupled to a network 108. Network 108 may include one or more computing networks available today, such as other LANs, wide area networks (WANs), the Internet, and/or other remote networks, in order to transfer data between client devices 104A-E and backend cloud or server resources platform/network 110. Each of the computing networks within network 108 may contain wired and/or wireless programmable devices that operate in the electrical and/or optical domain. For example, network 108 may include wireless networks, such as cellular networks in addition to cellular network 103. Wireless networks may utilize a variety of protocols and communication techniques (e.g., Global System for Mobile Communications (GSM) based cellular network) wireless fidelity Wi-Fi networks, Bluetooth, Near Field Communication (NFC), and/or other suitable radio-based networks as would be appreciated by one of ordinary skill in the art upon viewing this disclosure. Network 108 may also employ any number of network communication protocols, such as Transmission Control Protocol (TCP) and Internet Protocol (IP). Although not explicitly shown in FIG. 1, network 108 may include a variety of network devices, such as servers, routers, network switches, and/or other network hardware devices configured to transport data over networks.

In FIG. 1, backend cloud or server resources platform/network 110 is illustrated as a remote network (e.g., a cloud network) that is able to communicate with client devices 104A-E via customer network 102 and network 108. Backend cloud or server resources platform/network 110 acts as a platform that provides additional computing resources to the client devices 104A-E and/or customer network 102. For example, by utilizing backend cloud or server resources platform/network 110, users of client devices 104A-E may be able to build and execute applications, such as automated processes for various enterprise, IT, and/or other organization-related functions. In one embodiment, backend cloud or server resources platform/network 110 includes one or more data centers 112, where each data center 112 could correspond to a different geographic location. Within a particular data center 112 a cloud service provider may include a plurality of server instances 114. Each server instance 114 may be implemented on a physical computing system, such as a single electronic computing device (e.g., a single physical hardware server) or could be in the form a multi-computing device (e.g., multiple physical hardware servers). Examples of server instances 114 include, but are not limited to, a web server instance (e.g., a unitary Apache installation), an application server instance (e.g., unitary Java Virtual Machine), and/or a database server instance (e.g., a unitary MySQL catalog).

To utilize computing resources within backend cloud or server resources platform/network 110, network operators may choose to configure data centers 112 using a variety of computing infrastructures. In one embodiment, one or more of data centers 112 are configured using a multi-tenant cloud architecture such that a single server instance 114, which can also be referred to as an application instance, handles requests and serves more than one customer. In some cases, data centers with multi-tenant cloud architecture commingle and store data from multiple customers, where multiple customer instances are assigned to a single server instance 114. In a multi-tenant cloud architecture, the single server instance 114 distinguishes between and segregates data and other information of the various customers. For example, a multi-tenant cloud architecture could assign a particular identifier for each customer in order to identify and segregate the data from each customer. In a multitenancy environment, multiple customers share the same application, running on the same operating system, on the same hardware, with the same data-storage mechanism. The distinction between the customers is achieved during application design, thus customers do not share or see each other's data. This is different than virtualization where components are transformed, enabling each customer application to appear to run on a separate virtual machine. Generally, implementing a multi-tenant cloud architecture may have a production limitation, such as the failure of a single server instance 114 causing outages for all customers allocated to the single server instance 114.

In another embodiment, one or more of the data centers 112 are configured using a multi-instance cloud architecture to provide every customer its own unique customer instance. For example, a multi-instance cloud architecture could provide each customer instance with its own dedicated application server and dedicated database server. In other examples, the multi-instance cloud architecture could deploy a single server instance 114 and/or other combinations of server instances 114, such as one or more dedicated web server instances, one or more dedicated application server instances, and one or more database server instances, for each customer instance. In a multi-instance cloud architecture, multiple customer instances could be installed on a single physical hardware server where each customer instance is allocated certain portions of the physical server resources, such as computing memory, storage, and processing power. By doing so, each customer instance has its own unique software stack that provides the benefit of data isolation, relatively less downtime for customers to access backend cloud or server resources platform/network 110, and customer-driven upgrade schedules.

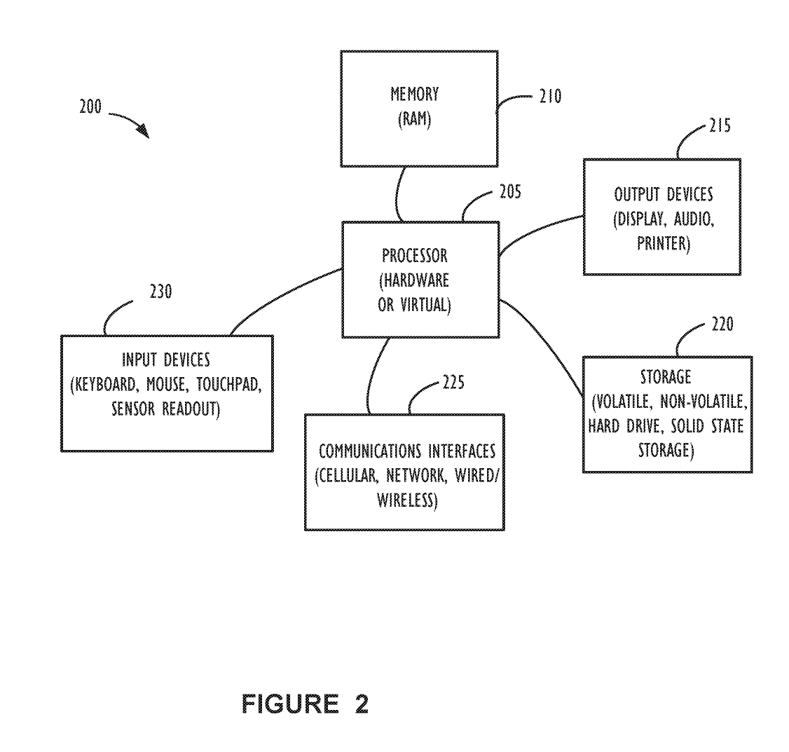

FIG. 2 illustrates a high-level block diagram 200 of a processing device (computing system) that may be used to implement one or more disclosed embodiments (e.g., a service provider cloud infrastructure such as backend cloud or backend server resources 110, client devices 104A-104E, server instances 114, data centers 206A-206B, etc.). For example, computing device 200, illustrated in FIG. 2, could represent a client device or a physical server device and could include either hardware or virtual processor(s) depending on the level of abstraction of the computing device. In some instances (without abstraction) computing device 200 and its elements as shown in FIG. 2 each relate to physical hardware and in some instances one, more, or all of the elements could be implemented using emulators or virtual machines as levels of abstraction. In any case, no matter how many levels of abstraction away from the physical hardware, computing device 200 at its lowest level may be implemented on physical hardware. As also shown in FIG. 2, computing device 200 may include one or more input devices 230, such as a keyboard, mouse, touchpad, or sensor readout (e.g., biometric scanner) and one or more output devices 215, such as displays, speakers for audio, or printers. Some devices may be configured as input/output devices also (e.g., a network interface or touchscreen display). Computing device 200 may also include communications interfaces 225, such as a network communication unit that could include a wired communication component and/or a wireless communications component, which may be communicatively coupled to processor 205. The network communication unit may utilize any of a variety of proprietary or standardized network protocols, such as Ethernet, TCP/IP, to name a few of many protocols, to effect communications between devices. Network communication units may also comprise one or more transceivers that utilize the Ethernet, power line communication (PLC), Wi-Fi, cellular, and/or other communication methods.

As illustrated in FIG. 2, processing device 200 includes a processing element, such as processor 205, that contains one or more hardware processors, where each hardware processor may have a single or multiple processor cores. In one embodiment, the processor 205 may include at least one shared cache that stores data (e.g., computing instructions) that are utilized by one or more other components of processor 205. For example, the shared cache may be a locally cached data stored in a memory for faster access by components of the processing elements that make up processor 205. In one or more embodiments, the shared cache may include one or more mid-level caches, such as level 2 (L2), level 3 (L3), level 4 (L4), or other levels of cache, a last level cache (LLC), or combinations thereof. Examples of processors include, but are not limited to a central processing unit (CPU) microprocessor. Although not illustrated in FIG. 2, the processing elements that make up processor 205 may also include one or more other types of hardware processing components, such as graphics processing units (GPUs), application specific integrated circuits (ASICs), field-programmable gate arrays (FPGAs), and/or digital signal processors (DSPs).

FIG. 2 illustrates that memory 210 may be operatively and communicatively coupled to processor 205. Memory 210 may be a non-transitory medium configured to store various types of data. For example, memory 210 may include one or more storage devices 220 that comprise a non-volatile storage device and/or volatile memory. Volatile memory, such as random access memory (RAM), can be any suitable non-permanent storage device. The non-volatile storage devices 220 can include one or more disk drives, optical drives, solid-state drives (SSDs), tap drives, flash memory, read-only memory (ROM), and/or any other type memory designed to maintain data for a duration time after a power loss or shut down operation. In certain instances, the non-volatile storage devices 220 may be used to store overflow data if allocated RAM is not large enough to hold all working data. The non-volatile storage devices 220 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 205. In one embodiment, the compiling process of the software program may transform program code written in a programming language to another computer language such that the processor 205 is able to execute the programming code. For example, the compiling process of the software program may generate an executable program that provides encoded instructions (e.g., machine code instructions) for processor 205 to accomplish specific, non-generic, particular computing functions.

After the compiling process, the encoded instructions may then be loaded as computer executable instructions or process steps to processor 205 from storage 220, from memory 210, and/or embedded within processor 205 (e.g., via a cache or on-board ROM). Processor 205 may be configured to execute the stored instructions or process steps in order to perform instructions or process steps to transform the computing device into a non-generic, particular, specially programmed machine or apparatus. Stored data, e.g., data stored by a storage device 220, may be accessed by processor 205 during the execution of computer executable instructions or process steps to instruct one or more components within the computing device 200.

A user interface (e.g., output devices 215 and input devices 230) can include a display, positional input device (such as a mouse, touchpad, touchscreen, or the like), keyboard, or other forms of user input and output devices. The user interface components may be communicatively coupled to processor 205. When the output device is or includes a display, the display can be implemented in various ways, including by a liquid crystal display (LCD) or a cathode-ray tube (CRT) or light emitting diode (LED) display, such as an OLED display. Persons of ordinary skill in the art are aware that the computing device 200 may comprise other components well known in the art, such as sensors, powers sources, and/or analog-to-digital converters, not explicitly shown in FIG. 2.

Collaboration within a company team may be enhanced when members of a team are encouraged to experiment with data interpretation without a concern that their work will affect other teams or reference data. Collaboration between teams may also be enhanced when different teams have a means of exchanging results outside of their individual teams. Collaboration between companies may also be enhanced when there exists a secure means of exchanging data with tracking of the communication and a common visualization of the data seen by both parties. In the present disclosure, this freedom within a team to innovate is promoted by the creation of “team” databases or segments of the main database. Accordingly, authorized users may be free to create and delete records within their team area. In order to insure that this activity does not affect the source records that may be used by other teams, these source records may be stored in a protected “master” database. Data to be shared with third parties may be copied to a “customer” database accessible, in a protected manner, by one or more third parties. Databases can be capable of storing records of varying file formats, such as text, image, audio or abstract data, and this disclosure applies to all types of records.

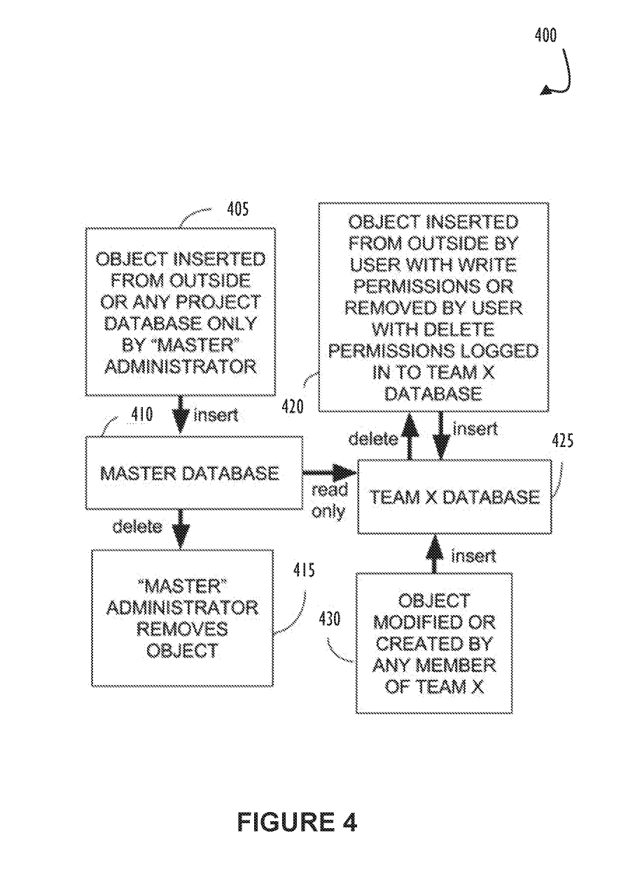

Database segmentation (logical or physical) may be used to separate database objects in one implementation. In another implementation, separation may be accomplished by the “tagging” of the database entry as to type (e.g., a database entry can belong to the master database, or to one or more team databases, or to a particular customer database). In one example of another implementation, there can be a hybrid where the master and team databases can be a logical partition of a single database while the customer databases are separate databases communicating with the logically partitioned master and team databases. In a logically partitioned database, one purpose of typing any database object may be to restrict access to the database object to an appropriate party. For example, only team members or administrators may have access to an object typed to that particular team. There are a number of means of restricting access to a database object once it is identified as a member of a particular type (e.g. as a member of teams A and B). For example, using the database permissions or by creating a table of objects that can be accessed by team A and restricting user access to only registered members of team A. An individual can be a member of more than one team and can then have access to all database objects registered to each team of which they are a member. If a database object is a registered to more than one team it is assumed that it can be modified by authorized members of either team. It is presumed that other restrictions may be imposed on access to a team object. One possible restriction may be that a team object can be assigned a priority and only team members can access a team database object if their personally assigned priority is equal to the object priority or a higher priority. Another restriction that may be attached to team members includes the assignment of edit rights within the team. Following this practice, within the team the user can be assigned permissions allowing certain “rights” such as read, write, delete, perform calculations within the team, read the master database, and import objects. It is expected that some team members will be restricted to write-only access (e.g. a field data acquisition team) or read-only access (e.g. financial auditors verifying reports). FIG. 4, which will be discussed below, illustrates one example of such permissions and operation within such permissions is referred to as an “authorized” operation.

In this example embodiment, only one master database has been detailed. However, it is anticipated that in other implementations more than one master database could be provided. When there is more than one master database, controlled access to each of the additional master databases may be provided as required by particular teams. That is, some teams may need access to the additional master databased and other may be prevented from accessing them. Indeed, some teams may not even be aware of the existence of master databases for which they have no access rights.

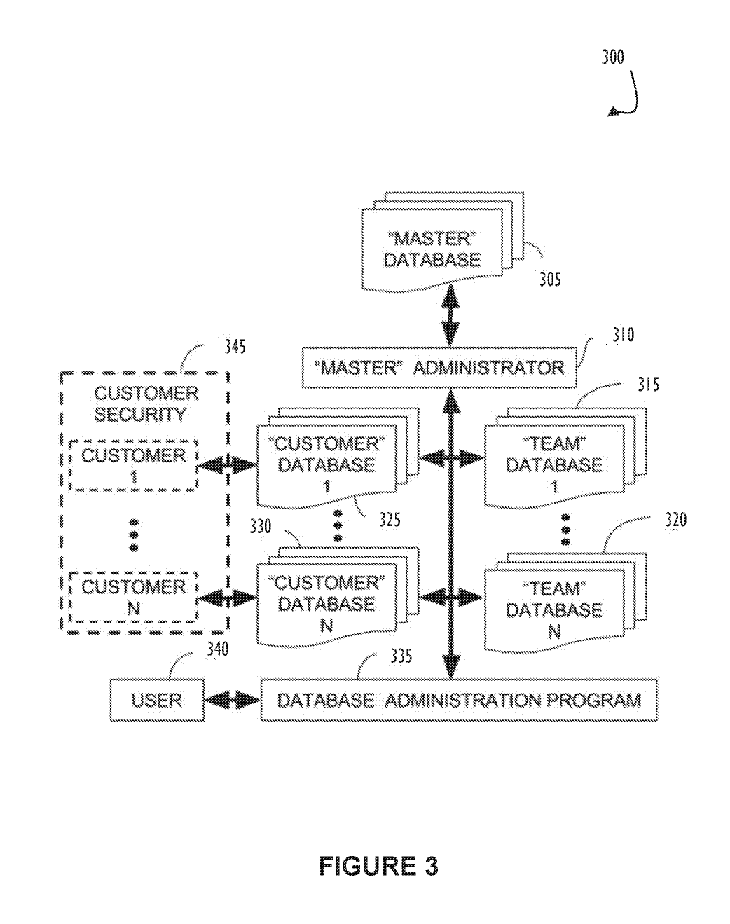

Referring now to FIG. 3, block diagram 300 provides an illustration of one possible relationship between databases and users according to one or more disclosed embodiments. While a number of individual databases are illustrated, the same result may be achieved by segmenting one or more databases into restricted areas within a larger single database. This discussion describes the database types as existing in separate databases, as in a plurality of database nodes or a vertically distributed database, with a means provided for moving or copying database items between databases. It is understood that the same result may be achieved by segregating (e.g., by permissions or tags) the database types within one or more databases. In block diagram 300, master database 305 represents the “master” database which contains critical data that should only be modified under the control of one or more “master” administrators 310. Master administrator 310 may be thought of as a “gatekeeper” that has the ability to add and delete records within “master” database 310. Access to records in “master” database 310 by other authorized members of the company is, in this example, restricted to “read-only” so that these records are available for use in calculations and can be modified (once copied to a team database 315-320) for team use. The results of the calculations and modifications represent records which are saved in the team database 315 associated with the user who initiated the calculation or modification. In practice, there may be a minimum of one “team” database (e.g., team database 1 (315)), but it would be expected that a number of separate team databases (as indicated at 320) would be created. For example, often in oil companies, different teams would examine different production zones of an oilfield rather than different groups examining different wells within that field. If a particular log represents the results of the gamma-ray measurements within a well, that log would intercept a number of production zones and be of interest to a number of teams. A team examining a particular zone in a well may want to modify a log to conform to other logs or other information. For example, they may want to stretch the gamma-ray log to compensate for drill-string compression in the vicinity of the production zone of interest to them when the log was taken. Traditionally, this editing could affect this edited gamma-ray log in other zones so that other teams would be affected by such editing, resulting in conflict between the teams. In the current disclosure, this “side artifact” or conflict may be avoided by maintaining the original gamma-ray curve in the “master” database and locating the modified gamma-ray curve in the team database of the modifier, where it can be used in further calculations to test the validity of the modifications. At the same time, other teams may continue to use the original gamma-ray log in the “master” database for their calculations independent of any other team's modifications. For example, an edited data record in team database 1 (315) would not be visible to a member of team database N (320) unless the edited data record is made available to database N (e.g., via an update to master database 305). If it is determined that the modified data record was an incorrect interpretation then the modified data record in team database 1 (315) can be deleted without impact to team database N (320), or any other team database. This separation by teams may also serve to isolate teams that are looking at a different aspect of the well. For example, a geology group's team which will have a different view and editing requirement than a petrophysicist team. By this means the flexibility to innovate and try new interpretations in team 1 is enhanced by avoiding any chance of impacting the simultaneous interpretations in the same well being done in team N or any other team that might be investigating the same well. At some future point if the modifications are shown to be an improvement, then any offset in other well zones can be evaluated and accepted modifications to the original gamma-ray curve can replace the gamma-ray curve in the “master” database when admitted by master database administrator 310.

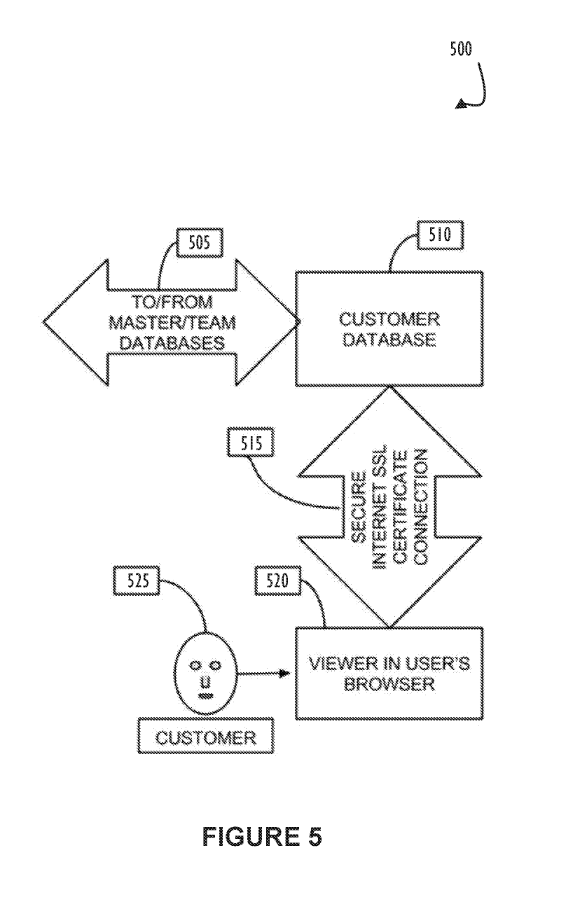

If the company deals with third parties such as an involvement with a client or customer there may need to be a way to communicate selected data from the database to that third party. For example, if the gamma-ray log is to be communicated, the log can be converted to an industry standard form (e.g. DLIS or LAS) and the file sent to the third party. This transfer may be subject to security concerns. Further, the outside party may use a different viewer that may represent the data without the original view settings. The viewer difference may lead to some misrepresentation of the intended information. In other industries and file formats a similar may exist with the transmittal of other types of data (e.g. reports, photographs, figures, etc.). To address these and other issues, customer database 325 may be populated by the curves, records and views that the company wishes the third party to see. In some embodiments, a different customer database (represented by customer database N (330)) may be provided for each interested third party. A further discussion of interactions (including customer security 345) with customer database (e.g., customer database 1 325) is provided below with reference to FIG. 5. There can be any number of “customer” databases, with a minimum of zero “customer” databases if all work is internal to the company, up to “customer” database N 325.

Continuing with FIG. 3, database administration program 335 may be used to connect company internal user 340 to the appropriate records in the “master”, “team” and “customer” databases. A systems administrator (not shown) may configure overall rights throughout the system. The system administrator may assign a user access to any number of databases. Further, records within a database could have priority levels with any given user requiring at least as high priority level to access the record.

Referring now to FIG. 4, block diagram 400 illustrates one possible interaction between master database (305 in FIG. 3) and a particular team database (e.g., team database 1 315 in FIG. 3). An aspect of this interactional relationship is the permissions inherent in each type of database. Defining a database as the master database (e.g., 305 in FIG. 3) defines that only administrators can add an element (405) or delete an element (415). Defining database X (425) as a team database defines that there will be a list of members, each of which will have their own set of permissions in that database. For example, almost everyone by default would have read permission, but write and delete permission may want to be restricted. Other employees may have no access to this database. After definition of a team database, members logged into this database may have read-only access to master database 410 for the purpose of using master database elements for calculations and edits. When any new database object is created by a currently logged-in member of team X through insertion (420) modification of an existing object (430) which may be a result of a calculation, that new object will then be located in the team X database (425). Recall that team members cannot write to master database 305. Accordingly, results of their work and intermediate steps may be stored within their respective team database.

An additional aspect of collaboration between companies, as disclosed herein, includes use of a controlled, secure avenue for communication between the parties. FIG. 5 illustrates one proposed implementation of the communication (e.g., customer security 345 of FIG. 3) showing how a “customer” database (e.g. 315 in FIGS. 3 and 510 in FIG. 5) may be configured to communicate with a “customer” 525, defined as any third party with which the company wishes to communicate. Security concerns or implementation requirements may dictate that this “customer” database 510 be an actual database independent of the “master” and team databases assist in preventing any “leak” of data from (or any problems in) the company databases. A company database entry which is to be shown to a customer may be copied, as represented by 505, from the company database (e.g., master or team) to customer database 510 corresponding to that customer 525. A company may set up a policy to determine which records could be transferred to a “customer” database 510. In one case, it could be chosen that only data records from the “master” database could be transferred to a “customer” database and to maintain a record of what was transferred. In another case, the company could decide data records could be transferred from a “team” database to a client database if the team member(s) has appropriate permission. Customer database 510 could be a secure logical partition of the company database. In this case, the transfer of data record 505 represents a transfer of a “local” copy of the company database entry to the partitioned customer database 510. Alternatively, customer database 510 may be a physically or geographically separate database. This may be preferred, for example, to limit any “leakage” between company and customer data and for performance reasons. In this case, the transfer of the data record 505 may be performed using a web server handling secure transfer (e.g. HTTPS or IPsec or VPN or other secure transfer methods known in the art). A separate database can be within the same or a separate server or cloud instance. Recall, that a database logical partition refers to a logical separation of objects within the database such that objects can be distinguished. This could, for example, be accomplished by endowing each object with an attribute (e.g. called “team”) so that members of a team could be given access to only objects where the “team” attribute matches a user's assigned team membership. With either a database logical partition or a separate database a secure connection may be made available to the internet. A user 525 who wishes to access customer database 510 may require access to the customer database internet port prior to using network access protocols. For example, 515 is illustrative of a HTTPS certificate and password connection between the user's computer browser 520 and customer database 510. Once communication is established, an application allowing viewing of the contents of customer database 510 can be downloaded to the user's computer browser 520, e.g. using JavaScript. A “viewer” refers to code that interprets the abstract database objects (ASCII, log data tables, JPEG representations, etc.) and renders this abstract data into a meaningful representation (e.g. text, graphical curves, pictures, etc.). Optionally, once secure connection 515 is established the downloaded code could also upload from the client's computer to the customer database data records selected by the user 510 for inclusion in customer database 510. The visualization of customer database 510 in user's browser 520 could also include company information, company promotional displays and other information that company wishes to convey to customer 525 and which need not be in the company database. The use of “customer” database 510 with its own viewer could provide valuable information on when and by whom this shared information was accessed. This could, for instance, log a record of customer access and provide notification if the customer has not accessed the information in a reasonable time to allow follow-up to insure the customer is aware of the new information.

The establishment of these types of database entries (master, team or customer) can be accomplished by the creation of communicating databases. One implementation includes the creation of a single database where the master and team databases coexist. The database can be designed to establish “roles” granting users privileges such as the ability read, modify or write database objects on a per-user basis. PostgreSQL GRANT commands are examples of such privilege grantings. In addition, objects can have row security policies that restrict, on a per-user basis, which rows can be returned by normal queries or inserted, updated, or deleted by data modification commands. PostgreSQL ALTER TABLE . . . ENABLE ROW LEVEL SECURITY is an example of object-centered permission granting. One embodiment of this disclosure may utilize a combination of user and database object permissions to achieve what appears to be a segmentation of a single database (e.g., company database) into master and team databases (see 305 and 315 from FIG. 3).

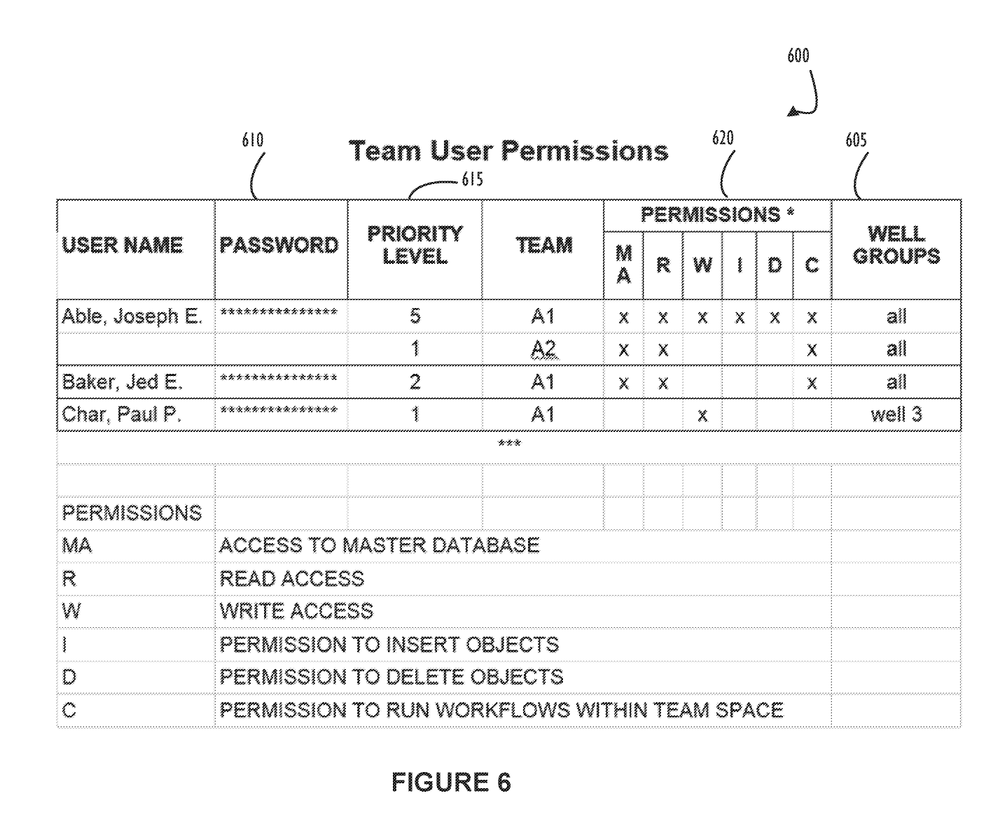

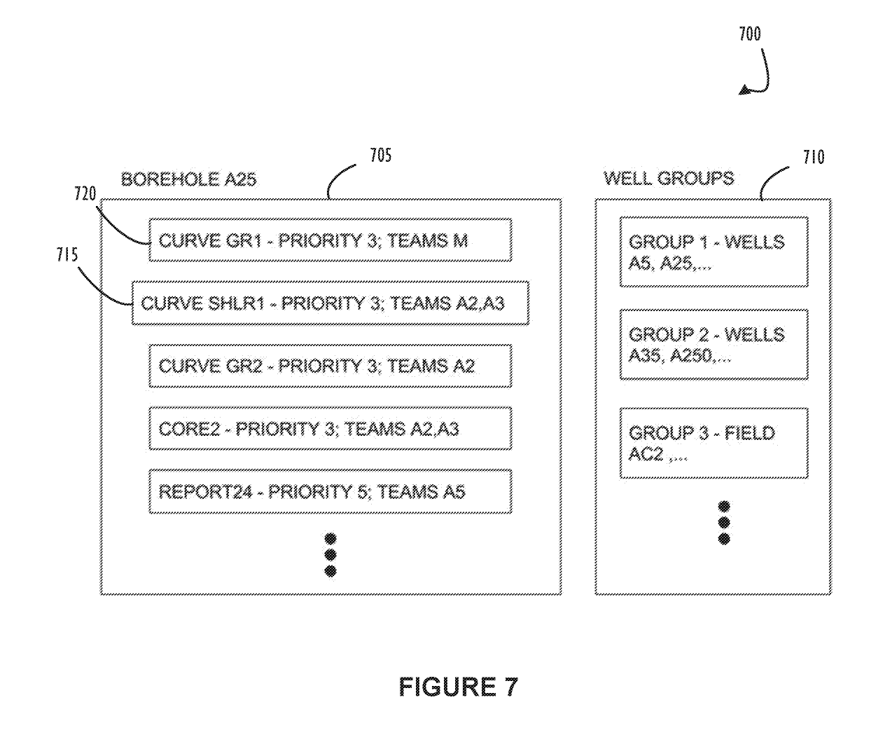

Referring now to FIGS. 6 and 7, table 600 illustrates one set of possible permissions that could be granted across a set of users who are assigned to one or more teams, granted a priority level within the team to allow discrimination as to the level of data to which they have access, assigned specific privileges as to what they are allowed to do with database objects, and are designated as to which well or group of wells they can exercise those privileges. FIG. 7 illustrates that there may be a database table assigning each database object on which these privileges are to be exercised. For example, wells (e.g., oil well) may be assigned to one or more well groups so that a user who accessing a well can be restricted to well groupings to which he is authorized (e.g., via permissions table 600). In addition, each data object, in this case the objects under keyword BOREHOLE A25 (705), may be assigned a priority and a group so that access to the database object can be restricted. For example, CURVE SHLR1 (715) can be restricted to users granted the object priority or higher and be a member of a specified group, in this example have priority 3, 4 or 5 and be a member of teams A2 or A3. A user can be restricted by database administration program (335 in FIG. 3) to logging into the database as the member of a single team. In this example, if a user logs in as user A2, any new or modified database objects generated by a user using such login will be automatically assigned the priority level of the user and team access under which the login was executed. Note that CURVE GR1 (720) is designated with team M, which in this case indicates that it is an element of the master database. Accordingly, CURVE GR1 (720) can only be accessed by any user with permissions MA in table 600 of FIG. 6. Also, because this is in the master database (510), this access is in a read-only mode. Only system administrators who control the contents of the master database can change such objects or add objects with a M type team designation.

In one embodiment, customer database 325 may be a separate database where SQL queries of database objects from the master or team databases can be copied to a customer database. This implementation may provide another security barrier protecting the master and team databases. Each customer database may have an independent connection to a web server with appropriate security. The web server can have JavaScript-type code for the display of data to customers, converting curves to plots and files to downloadable common formats such as PDF. Thus, allowing user viewing of content before downloading. Provision can also be made in the viewer code to allow uploading of third party code for two-way communication.

With the permissions illustrated in Table 600 it is assumed that each team is assigned one or more basins, fields, wells, boreholes or associated zones (team well group). Within this well group each team member can be limited to all designated wells or limited further to particular locations (column 605 in Table 6). Each user may be provided with a means of authentication with the system (e.g. password column 610 in Table 6) after which a particular team login may also be selected. This operation may only be facilitated if that user is an established member of that team as provided by a user's permissions such as is shown in Table 600. When a user is assigned to a team, the user can be assigned an access priority (column 615 of Table 6) so that team database objects within the team database can be further restricted to team members with sufficient access priority. This would be useful, for instance, where documents associated with a well have financial implications requiring restrictions to only management review. Within a team, each user can be assigned permissions such as shown in the permissions column 620 of Table 6. The satisfaction of the totality of such permissions results in a user being “authorized” in that role.

It should be evident that the team database or database segment is not for the purpose of restricting access to an element of the database for only security as in an access control system. Rather it is a method of organization of the database system in a manner to promote collaboration within and between companies. While some the access features of the master and team databases could be accomplished by the permission systems within a conventional database, the ancillary features of the customer database could not. In addition, the formation of the enumerated database types in this system (master, team and customer) provides a system that is easily understood and used, and simplifies the organization of permissions to essentially team membership and security level, as read/write/delete privileges can be tied to the security level.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a memory;
a storage area containing one or more databases communicatively coupled to the memory; and
one or more processing units, communicatively coupled to the memory and the storage area, wherein the memory stores instructions that when executed by the one or more processing units cause the one or more processing units to:
maintain access rights to a master database portion, a team database portion, and a customer database portion, each portion comprising a plurality of objects stored in the one or more databases and separated by logically or physically segmenting the plurality of objects for each portion within the one or more databases;
control access by one or more teams to the plurality of objects stored in the team database portion, at least in part, by logically or physically segmenting the plurality of objects into a set of team databases based on the one or more teams, each team of the one or more teams having one or more team users identified as being a member of the each team;
control access to the plurality of objects stored in the master database portion to one or more admin users designated as master database administrators; and
control access by one or more customers to the plurality of objects stored in the customer database portion, at least in part, by logically or physically segmenting the plurality of objects into a set of customer databases based on the one or more customers, each customer of the one or more customers having one or more customer users designated as having access rights for the each customer,
wherein the team users have at most read-only access to objects stored in the master database portion,
wherein the customer users are restricted to accessing only the plurality of objects in a customer database for which they are designated,
wherein only said admin users have access rights to add, delete, and edit the plurality of objects stored in said master database portion and are restricted to add entries to said master database portion only by importing external data records or transferring entries from said team database portion, and
wherein results of calculations, edits, or importing external data records by a team user are stored in a team database determined based on current authentication attributes of the team user.

2. The computer system of claim 1, wherein only the team users have access rights to add, delete, and edit the plurality of objects stored in the team database determined based on current authentication attributes of the team user.

3. The computer system of claim 1, further comprising a network communication interface communicatively coupled to the memory, the storage area, and the one or more processors and wherein the one or more processing units are further configured to provide a secure network connection, via the network communication interface, to a device associated with a customer user and allow access to data records stored in a customer database for which the customer user is designated.

4. The computer system of claim 3, wherein the secure network connection comprises an encrypted Internet connection.

5. The computer system of claim 3, wherein the one or more processing units are further configured to provide a viewer for viewing data from the customer database portion.

6. The computer system of claim 1, wherein only said admin users or said team users have access rights to add, delete, and edit the plurality of objects stored in said customer database portion and are restricted to add entries to said customer database portion only by transferring entries from said team database portion or said master database portion.

7. The computer system of claim 1, wherein the one or more processing units are further configured to provide an auditing function to track updates and access to data in any of the one or more databases.

8. The computer system of claim 7, wherein the one or more processing units are further configured to generate an alert upon access by the customer user or failure to access by the customer user within a pre-defined time period.

9. The computer system of claim 1, wherein said master database portion, said team database portion, or said customer database portion is hosted, at least in part, on cloud based infrastructure.

10. A non-transitory computer readable medium, comprising instructions stored thereon that, when executed by one or more processing units, cause the one or more processing units to:
maintain access rights to a master database portion, a team database portion, and a customer database portion, each portion comprising a plurality of objects stored in the one or more databases and separated by logically or physically segmenting the plurality of objects for each portion within the one or more databases;
control access by one or more teams to the plurality of objects stored in said team database portion, at least in part, by logically or physically segmenting the plurality of objects into a set of team databases based on the one or more teams, each team of the one or more teams having one or more team users identified as being a member of the each team;
control access to the plurality of objects stored in the master database portion to one or more admin users designated as master database administrators; and
control access by one or more customers to the plurality of objects stored in said customer database portion, at least in part, by logically or physically segmenting the plurality of objects into a set of customer databases based on the one or more customers, each customer of the one or more customers having one or more customer users designated as having access rights for the each customer,
wherein said team users have read-only access to objects stored in said master database portion,
wherein said customer users are restricted to accessing only the plurality of objects in a customer database for which they are designated,
wherein only said admin users have access rights to add, delete, and edit the plurality of objects stored in said master database portion and are restricted to add entries to the master database portion only by importing external data records or transferring entries from said team database portion, and
wherein results of calculations, edits, or importing external data records by a team user are stored in a team database determined based on current authentication attributes of the team user.

11. The non-transitory computer readable medium of claim 10, wherein, based on the instructions to configure the one or more processing units, only the team users have access rights to add, delete, and edit the plurality of objects stored in the team database determined based on current authentication attributes of the team user.

12. The non-transitory computer readable medium of claim 10, further comprising instructions to cause the one or more processing units to provide a secure network connection, via a network communication interface, to a device associated with a customer user and allow access to data records stored in a customer database for which the customer user is designated.

13. The non-transitory computer readable medium of claim 12, wherein the secure network connection comprises an encrypted Internet connection.

14. The non-transitory computer readable medium of claim 13, further comprising instructions to configure the one or more processing units to provide a viewer for viewing data from the customer database portion.

15. The non-transitory computer readable medium of claim 10, wherein, based on the instructions to configure the one or more processing units, only the admin users or the team users have access rights to add, delete, and edit the plurality of objects stored in the customer database portion and are restricted to add entries to the customer database portion only by transferring entries from the team database portion or the master database portion.

16. The non-transitory computer readable medium of claim 10, wherein the instructions further comprise instructions to configure the one or more processing units to provide an auditing function to track updates and access to data in any of the one or more databases.

17. The non-transitory computer readable medium of claim 16, wherein the instructions further comprise instructions to configure the one or more processing units to generate an alert upon access by the customer user or failure to access by the customer user within a pre-defined time period.

18. A computer system, comprising:
a memory;
a storage area containing one or more databases communicatively coupled to the memory; and
one or more processing units, communicatively coupled to the memory and the storage area, wherein the memory stores instructions that when executed by the one or more processing units cause the one or more processing units to provide a means for:
maintaining access rights to a master database portion, a team database portion, and a customer database portion, each portion comprising a plurality of objects stored in the one or more databases and separated by logically or physically segmenting the plurality of objects for each portion within the one or more databases;
controlling access by one or more teams to the plurality of objects stored in the team database portion, at least in part, by logically or physically segmenting the plurality of objects into a set of team databases based on the one or more teams, each team of the one or more teams having one or more team users identified as being a member of the each team;
controlling access to the plurality of objects stored in the master database portion to one or more admin users designated as master database administrators; and
controlling access by one or more customers to the plurality of objects stored in the customer database portion, at least in part, by logically or physically segmenting the plurality of objects into a set of customer databases based on the one or more customers, each customer of the one or more customers having one or more customer users designated as having access rights for the each customer,
wherein said team users have read-only access to objects stored in said master database portion,
wherein said customer users are restricted to accessing only the plurality of objects in a customer database for which they are designated,
wherein only said admin users have access rights to add, delete, and edit the plurality of objects stored in said master database portion and are restricted to add entries to said master database portion only by importing external data records or transferring entries from said team database portion, and
wherein results of calculations, edits, or importing external data records by a team user are stored in a team database determined based on current authentication attributes of the team user.

19. The computer system of claim 18, wherein only said admin users or said team users have access rights to add, delete, and edit the plurality of objects stored in said customer database portion and are restricted to add entries to said customer database portion only by transferring entries from said team database portion or said master database portion.

20. A database means for improving collaboration by segregating user access to database objects into at least three areas:
At least one master database with an authorized administrator having write/delete access privileges with all others having at most read-only privileges when authorized;
At least one team database with authorization restricted to only team members having read/write/delete privileges when authorized for objects within said team database with all objects created, imported, or modified by said team members while authenticated with a team database remaining within said team database; and.
at least one customer database whose objects have read/write authorization by authorized said team members or said authorized administrator and whose objects have read/write authorization by authenticated third parties utilizing enhanced security.
